(19) United States
(12) Patent Application Publication
(10) Pub. No.: US 2025/0336039 A1
(43) Pub. Date: Oct. 30, 2025

(54) Super-Resolution Image Upscaling With Compression Artifact Restoration

(71) Applicant: Google LLC, Mountain View, CA (US)

(72) Inventors: Yinxiao Li, Sunnyvale, CA (US); Feng Yang, Sunnyvale, CA (US); Keyang Xu, Santa Clara, CA (US); Hongliang Fei, Sunnyvale, CA (US); Yutian Wu, Sunnyvale, CA (US); Xiaohang Li, Cupertino, CA (US); Dongdong Wang, Sunnyvale, CA (US); Yicong Tian, Sunnyvale, CA (US); Haifeng Gong, Fremont, CA (US)

(21) Appl. No.: 18/648,915

(22) Filed: Apr. 29, 2024

(51) Int. Cl. G06T 5/60; G06T 3/4053; G06T 5/70

(52) U.S. Cl. CPC G06T 5/60; G06T 3/4053; G06T 5/70; G06T 2207/20076; G06T 2207/20081; G06T 2207/20084

(57) ABSTRACT

Methods, systems, and apparatus, including computer-readable storage media for super-resolution upscaling of compressed images with compression artifact restoration. A diffusion model is fine-tuned on randomly compressed images labeled with a corresponding compression quality factor for each image to perform super-resolution upscaling while correcting for compression artifacts in the image. Compressed image training data can be labeled according to a model trained to predict compression quality factors from input compressed images. Model processing of a pixel-based diffusion model can be improved with a consistency model mapping noised images during the diffusion stage of a diffusion model to the original input image. A consistency model and a pixel-based diffusion model can be trained together. Thereafter, the consistency model can be used to generate images from noise in a single step, versus performing multiple steps as in the diffusion stage of the pixel-based diffusion model.

### BACKGROUND

A diffusion model is a type of generative artificial intelligence (AI) model for generating new data similar to the training data used to train the model. The diffusion model can include two stages: a diffusion stage and a denoising stage. In the diffusion stage, noise is added to the input image over a sequence of steps. In the denoising stage, the diffusion model generates new data by learning a process to reverse the noise added in the diffusion stage. A diffusion model may be a latent-space diffusion model or a pixel-space diffusion model. A pixel-space diffusion model denoises pixel values of an image to generate an output, while a latent-space diffusion model denoises a latent or internal representation of an input generated by the model. A pixel-space diffusion model does not depend on an encoder or a decoder, unlike a latent-space diffusion model. Diffusion models can be used for a variety of tasks, including super-resolution imaging. Super-resolution imaging refers to a class of techniques for increasing or improving the resolution of input images.

Images may be compressed according to various compression techniques. The compression can be lossy or lossless. A lossy compression is a form of compression in which data of an image is lost during the compression and not recoverable when the image is de-compressed, resulting in irregularities or errors referred to as compression artifacts. A lossless compression is a form of compression in which data is recoverable when the compressed image is later de-compressed. An image can be lossily compressed according to a compression quality factor, representing a trade-off between higher quality, e.g., less data loss, versus faster processing to compress the image. A higher compression quality factor corresponds to a higher quality compressed image while a lower compression quality factor corresponds to a lower quality compressed image.

### BRIEF SUMMARY

Aspects of the disclosure are directed to an image processing system for performing super-resolution upscaling on compressed images with compression artifacts. The system includes a diffusion model fine-tuned on training data including randomly compressed images labeled with a corresponding compression quality factor for each image. The training data is used to fine-tune a pre-trained diffusion model to perform super-resolution upscaling while correcting for compression artifacts in the image. Compressed image training data can be labeled according to a model trained to predict compression quality factors from input compressed images.

Aspects of the disclosure are also directed to techniques for improving pixel-space diffusion model processing using a consistency model. A consistency model is a function mapping a noised input image during the diffusion stage of a diffusion model to the original input image. A consistency model and a pixel-based diffusion model can be trained together, using an objective to update model parameters of both models so as to cause the consistency model to generate the input image from any step in the diffusion stage of the pixel-based diffusion model. Thereafter, the consistency model can be used to generate images from noise in a single step, versus performing multiple steps as in the diffusion stage of the pixel-based diffusion model.

Other implementations of these and other aspects include corresponding computer systems, apparatus, and computer programs recorded on one or more computer storage devices, each configured to perform the actions of the methods.

### BRIEF DESCRIPTION OF THE DRAWINGS

FIG. 1 is a block diagram of an example image processing system for performing super-resolution and compression artifact restoration, according to aspects of the disclosure.

FIG. 2 is a block diagram of a training engine for fine-tuning the super-resolution and compression artifact restoration model, according to aspects of the disclosure.

FIG. 3 is a block diagram of an image processing system implementing a pixel-space diffusion model with a consistency model, according to aspects of the disclosure.

FIG. 4 is a block diagram illustrating one or more models, such as for deployment in a datacenter housing a hardware accelerator on which the deployed models will execute for super-resolution upscaling with compression artifact restoration.

FIG. 5 is a flow diagram of an example process for generating super-resolution upscaled images with compression artifact restoration, according to aspects of the disclosure.

FIG. 6 is a flow diagram of an example process for training a consistency model using a pixel-space diffusion model, according to aspects of the disclosure.

FIG. 7 is a block diagram of an example computing environment for implementing an image processing system, according to aspects of disclosure.

### DETAILED DESCRIPTION

### Overview

Aspects of the disclosure are directed to an image processing system for performing super-resolution upscaling on compressed images with compression artifacts. A diffusion model can be trained to perform super-resolution upscaling on an input image, for example to generate a new image from an input image that is scaled up by a factor of two, four, eight, etc., while maintaining or improving the resolution of the output image relative to the input image. When the input image is lossily compressed, however, compression artifacts present in the input image also get scaled up. The diffusion model may exacerbate the errors or irregularities of the compression artifact in the output image.

A super-resolution and compression artifact restoration model as described herein can be trained and used to perform super-resolution upscaling of an input image, while also performing compression artifact restoration. The result is an output image generated from the diffusion model that does not carry over or worsen compression artifacts from the input image, which can be performed in a single end-to-end process. The output image includes fewer or no compression artifacts relative to the input image. To that end, processing the image from end-to-end avoids the need for multiple models to be executed, e.g., one for compression artifact restoration and another for super-resolution upscaling, and reduces computing resource usage over approaches in which images are processed over more than once to perform compression artifact restoration and super-resolution, separately.

Training data for augmenting super-resolution upscaling with compression artifact restoration includes training examples of compressed images compressed according to random compression quality factors. The compression quality factors can be data annotated or provided as part of the compressed image data that is input to the model. The model can use the annotated compression quality factor to improve the generalizability of the model against different input images. For example, the additional input of the quality factor provides an extra feature that can steer the training of the model to associate inputs as belonging to groups of compressed images of different levels of quality. The additional feature can allow the model to differentiate between lesser and greater quality images, which in turn may inform how the model handles compression artifact restoration.

The training data reflects real-world use cases in which images received for upscaling are provided with variable levels of compression artifacts. For example, images that are intended for display according to different formats, resolutions, or dimensions, may be subject to multiple levels of compression and decompression before being provided as model input. An example of this type of content is display advertisements, in which a base image may be repeatedly compressed and decompressed to fit various different display formats, while also being compressed for more efficient transmission between devices. Further, digital content with text is also more sensitive to degradation due to lossy compression. For example, display advertisements with small text may be distorted to varying degrees due to compression at different quality factors.

Randomly compressing data to provide as training data can improve the overall accuracy of the model, for example because the training data is a broader representation of the types of data the model may encounter once trained. Compressed data of different quality factors can simulate the real-world use case of upscaling images that are not of a uniform quality factor, as mentioned above. Further, the training data can be tailored to a specific domain or type of input images, e.g., images with text in various positions and of various lengths, such as what may be found in digital content for display, like display advertisements. Further, the image processing system can perform unconditional super-resolution and compression artifact restoration, meaning that the system can implement the corresponding model without attention layers or other model components for text input that would otherwise bottleneck processing at inference.

Aspects of the disclosure are also directed to techniques for improving pixel-space diffusion model processing using a consistency model. A diffusion model can include a diffusion stage and a denoising stage, each including operations at sequential steps to gradually add and remove noise to an input image, respectively. As performing multiple steps of either stage is performance intensive, aspects of the disclosure provide for using a consistency model with a pixel-based diffusion model to reduce performing the denoising stage to fewer steps of denoising operations, e.g., a single step. For example, the average time for one input served at inference can be reduced, for example from multiple seconds long, e.g., 12 seconds long, to less than one second, e.g., 0.3 seconds, through the use of the consistency model approach as described herein.

Pixel-space diffusion models do not depend on a pre-trained encoder or pre-trained decoder for image generation. As compared with latent-space diffusion models in which a latent representation of an input is learned and used to generate an output image, a pixel-space diffusion model is more likely to cover fine details and global coherent structures, for example to recover small text or detail in a raw image or a lossily compressed image.

Because the denoising stage typically includes multiple denoising operations in sequence, the consistency model's mapping from noised images to un-noised original images requires less data and context to store in memory relative to performing the multiple denoising operations. In addition, multiple iterations, e.g., thirty-two iterations of processing input through the diffusion model to iteratively refine the output are avoided by instead executing the consistency model. Further, consistency models for pixel-space diffusion models do not rely on pre-trained encoders or decoders that are trained with out-of-domain data, e.g., uncompressed images for a model trained to perform super-resolution upscaling with artifact restoration. Not relying on pre-trained encoders or decoders can reduce the risk of information loss, of which lossily compressed images with small, fine-detailed elements like text, are more sensitive to versus other types of images.

Reducing the number of operations performed also results in better and more stable restoration of an image, at least because the use of the consistency model can reduce the number of steps to one, therefore reducing possible points where the model may deviate and generate erroneous output. This increased stability in the restoration also improves the resolution of finer details in output, upscaled, images, particularly for fine text that may be found in some images, such as digital display advertisements.

### Example Systems

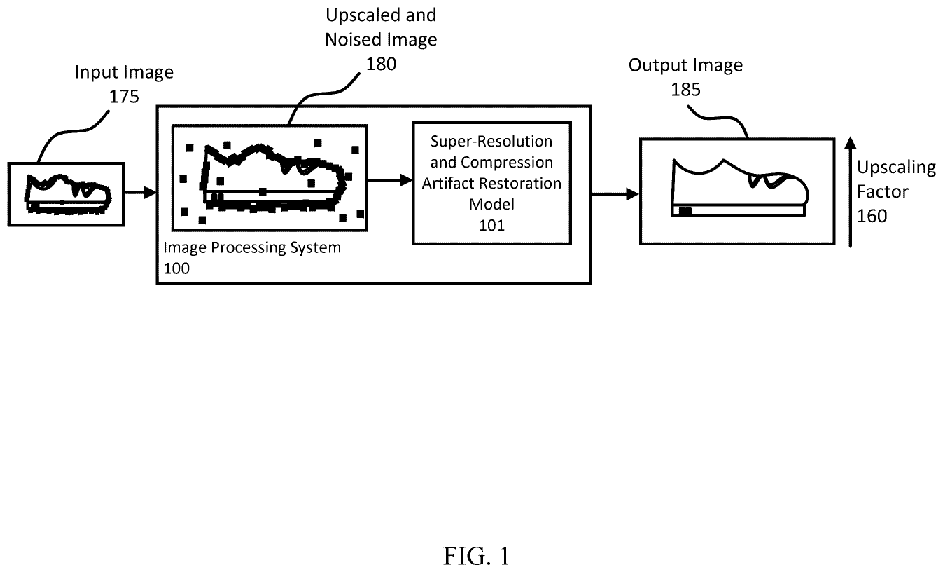

FIG. 1 is a block diagram of an example image processing system 100 for performing super-resolution and compression artifact restoration, according to aspects of the disclosure. Input image 175 is an image that has been compressed according to a lossy compression process. The input image 175 can be compressed, for example, using any lossy compression approach, such as approaches based on discrete cosine transforms, used in JPEG compression. The input image 175 can be a JPEG image. As a consequence of the lossy compression, the input image 175 can have one or more compression artifacts or other errors of lossy compression, reducing the quality of the input image 175 in some manner. For example, as a result of the compression, the input image 175 may be blurry in some or all parts of the image, and/or exhibiting irregularities adding noise to the image.

The quality of a compressed image can be measured according to a compression quality factor. A compression quality factor is a numerical value corresponding to a respective quality of a compressed image. The compression quality factor can scale with the quality of the compressed image. For example, a compression quality factor of zero may indicate no compression artifacts in a corresponding image. A compression quality factor of two may indicate some quantity of compression artifacts, e.g., more than a compressed image with a compression quality factor of one, but less than an image with a compression quality factor of three, and so on. An image can be compressed by a compression engine (not shown) configured to compress an image in accordance with an input compression quality factor. The selection of the compression quality factor can be a trade-off between processing time to compress the image, with the presence or severity of compression artifacts in the resulting compressed image.

The system 100 implements a super-resolution and compression artifact restoration model 101 (“model 101”) trained on examples of lossily compressed images of randomly determined compression quality factors, to learn to perform super-resolution without including compression artifacts in the input image to the output image. From the input image 175, the system 100 generates an output image 185, with fewer or no compression artifacts and upscaled according to an upscaling factor 160. Example upscaling factors are 2× or 4× upscaling, meaning that the resolution of the output image 185 can be two or four times higher than the resolution of the input image 175, in these respective examples. In some examples, the model 101 is trained to upscale input images according to a single upscaling factor, while in other examples, the model 101 may be trained to upscale images according to a selected one of several possible upscaling factors.

To generate the up-scaled output image 185, the system 100 can first scale the input image 175 up to the desired upscaling factor 160 and add a controlled amount of noise to the input image to generate upscaled and noised image 180. The system 100 can perform the upscaling according to any technique, for example using bilinear upscaling or another interpolative technique. The resultant image after upscaling according to these techniques will generally be lower in image quality, at least because interpolated pixels added to the image can cause the image to be inaccurate or blurry.

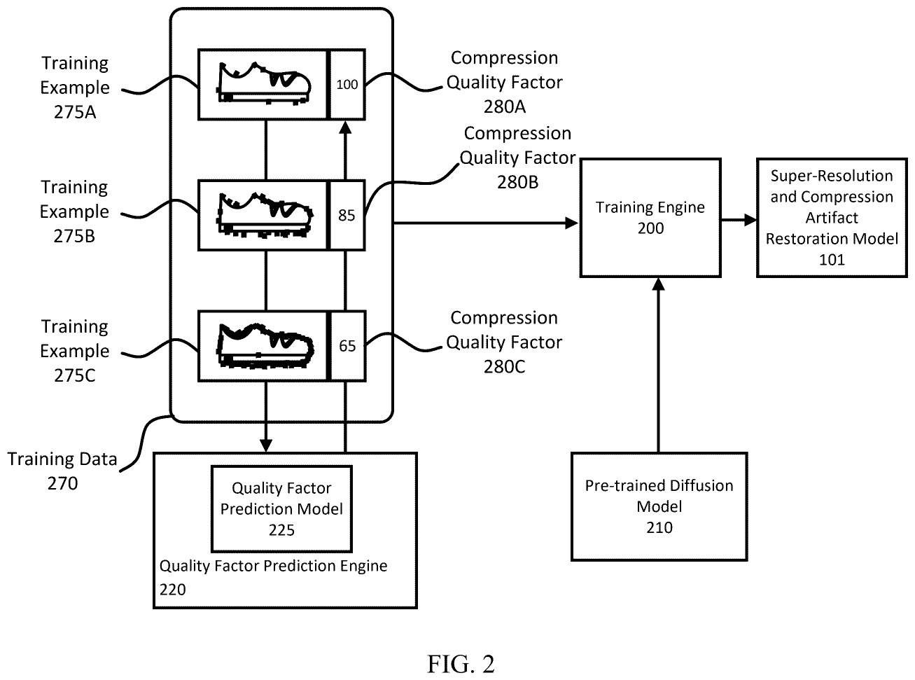

The controlled amount of noise added is a learnable model parameter, and the process for training the model 101 to determine the amount of noise to add is described herein with reference to FIG. 2. Other learnable parameters of the model 101 can include the type of noise added, e.g., Gaussian noise, the amount of noise added, and how the noise is added, e.g., by randomly permuting pixel values of the input image 175.

After generating the upscaled and noised image 180, the system 100 can process the image 180 through the model 101 to generate output image 185. The output image 185 can be any type of image intended for display in some form. For example, the input image 175 may be a base image from which various different images are generated, including the output image 185, which may be presented or displayed across monitors or displays of various resolutions, refresh rates, or sizes. The output image 185 may be, for example, a display advertisement to be displayed as a banner or alongside other digital content. For example, in response to a request for digital content, the system 100 can receive and generate the output image 185 in accordance with an upscaling factor matching the resolution of the screen or monitor on which the image will be displayed.

As described in more detail with reference to FIG. 2, the model 101 can be fine-tuned on training examples of images with various levels of quality in their compression. The underlying model can be a diffusion model, pre-trained to process an input image according to a diffusion stage and a denoising stage. Each stage can include a number of steps, corresponding to operations performed in sequence to gradually add noise, e.g., in the diffusion stage, or reduce noise, e.g., in the denoising stage. A diffusion stage may also be referred to as a forward process and the denoising stage may also be referred to as a reverse process. A diffusion model can also include a sampler or sampling process for sampling noised data to generate model output. An example sampling process can be a denoising diffusion implicit model (DDIM).

Applying a compressed image through a super-resolution model may exacerbate the image degradation caused by the compression artifacts in the image. A super-resolution model upscales the artifacts in addition to the rest of the image, causing the artifacts to be present in the output image. The model 101 is trained to account for compression artifacts. By training the model 101 on various training examples of compressed images of various compression quality factors, the model 101 avoids or reduces compression artifacts carried over from the input image 175 to the output image 185.

The combination of artifact restoration and super-resolution processing reduces processing time over approaches in which both processes are applied separately. Further, the augmentation of super-resolution models to restore compression artifacts improves the image quality of the resulting image, which in turn results in less waste of processing time incurred as a result of other approaches in which super-resolution output images are discarded for their compression artifacts.

FIG. 2 is a block diagram of a training engine 200 for fine-tuning the super-resolution and compression artifact restoration model 101, according to aspects of the disclosure. FIG. 2 shows a training engine 200, a pre-trained diffusion model 210, and a compression quality factor prediction engine 220.

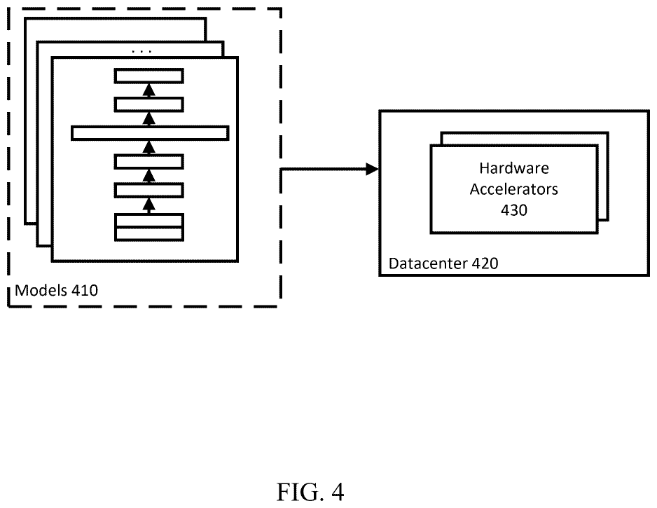

Training data 270 includes various training examples for training the model 101, including training examples 275A-275C. Each training example can be annotated with the respective compression quality factor corresponding to the level of compression for the image. The training data may or may not include duplicates of the same base image. Training examples can include images that are initially at the upscaling factor the model is being trained to process. As a pre-processing step, the training engine 200 can perform a form of down-sampling, e.g., bilinear down-sampling, on the training data examples to decrease their scale to the target upscaling factor. The original training images can be used as labels that the model is trained to re-created using the down-sampled training examples as inputs. As described herein with reference to FIG. 4, input data to the model 101 may be limited in size due to the hardware used to train or run the model 101 at inference. The training engine 200 can also be configured to pre-process the data to match the corresponding dimension or size requirements, as needed.

For example, the training data 270 may include examples of the same image at compression levels with respective compression quality factors. In addition, or alternatively, the training data 270 may also include different examples of images compressed with the same compression quality factor. Training data 270 can be selected to focus on images of a particular domain or type, e.g., images with and without text in various positions, such as what may be encountered in display advertisements. As shown in FIG. 2, training example 275A is labeled with compression quality factor 280A, having a value of one hundred; training example 275B is labeled with compression quality factor 280B, having a value of eighty-five; and training example 275C is labeled with compression quality factor 280C, having a value of sixty-five. The compression quality factors across the training data examples can be bounded, for example from sixty-five to one hundred, reflecting observed ranges of different compressed images encountered by the system.

As a compressed image may not be initially annotated with its corresponding compression quality factor, a compression quality factor prediction engine 220 can be implemented, e.g., as part of the system 100 or as part of one or more devices in different physical locations relative to devices of the system 100, for predicting the compression quality factor of an input image. For example, the compression quality factor prediction engine 220 can implement a compression quality factor prediction model 225 trained to classify an input compressed image according to the compression quality factor corresponding to its compression. The compression quality factor prediction model 225 can be trained according to a supervised learning approach, with training data including examples of compressed images annotated with a corresponding compression quality factor for each image. Training data for the compression quality factor prediction model 225 can be generated, for example using manual hand-labeling or by a compression engine. In examples in which a compression engine is used, the compression engine can be configured to compress images according to various compression quality factors and annotate a compressed image with a corresponding input compression quality factor.

The model can be trained to predict the compression quality factor on unannotated compressed images. The difference between a ground-truth compression quality factor and a predicted compression quality factor can be computed and used as a loss for performing backpropagation with gradient descent. Example loss functions that can be used include L1 loss or L2 loss, which may be used in weighted or unweighted forms. Model parameters for the compression quality factor prediction model 225 can be updated in accordance with the computed gradients, and the process can be repeated for a number of epochs or training iterations, until one or more stopping criteria are met. Stopping criteria can include meeting a predetermined number of training iterations, converging results between iterations within a predetermined threshold, or not meeting a predetermined minimum level of improvement between training iterations.

Although the following describes example model architectures and example training processes for fine-tuning a pre-trained diffusion model, it is understood that training engine 200 can perform the described training to generate the diffusion model 210, before fine-tuning the model 210 to augment the model to also perform compression artifact restoration. In some examples, the training engine 200 is configured to train an uninitialized model to perform both super-resolution and compression artifact restoration, without first separately training the model for super-resolution. In some examples, instead of pre-training and fine-tuning the diffusion model 210, the training engine 200 trains an un-trained version of the diffusion model 210, for example with randomly initialized model parameter values.

For example, during pre-training and for each diffusion step, the training engine 200 can add some amount of noise to the input image to an un-trained version of the diffusion model 210. This noise can be regarded as perturbations to the current image. The degree of the noise used to add perturbations to the current image depends on the current step in the diffusion stage. The type of noise can vary, for example Gaussian noise, Poisson noise, etc. Noise can be added by changing values, e.g., pixel values, within the input image. The amount of noise can be randomly sampled, to control the trade-off between image clarity and noise.

During pre-training and after a fixed number of diffusion steps, the process is reversed when the denoising stage of the diffusion model is executed. During the denoising stage, the training engine 200 controls and gradually reduces the level of noise added over successive steps in the diffusion stage to evolve into a more coherent and recognizable state over time. The diffusion model is pre-trained to return the image to a cleaner state, while retaining the generated content. Example loss functions that can be used to train the diffusion model include mean squared error (MSE), L2 loss, or huber loss, although any of a variety of loss functions for training super-resolution diffusion models may be used. For example, the training engine 200 can compute a loss as the difference between a denoised image generated by the model 210 and a ground-truth example of an upscaled and higher resolution input image, e.g., original input images in the training data before the images are down-sampled.

The denoising stage can be implemented as a U-net architecture with a number of sub-blocks, including convolutional and pooling neural network layers in which input is contracted and expanded during processing through the model. The pre-trained diffusion model 210 can be any of a variety of different types of models, e.g., pixel-space diffusion models operating on pixel values of input images, latent-space models operating on a learned latent representation of an input image, and so on.

At inference, the pre-trained diffusion model 210 can receive an input image with a controlled amount of noise added, to generate an upscaled version of the image as output. The controlled amount of noise is determined during pre-training and processing the input through the diffusion and denoising stages. A system, such as the system 100, can add the controlled amount of noise according to a stochastic process, e.g., to randomly generate and add noise, or by adding noise according to a predetermined schedule, which may vary the amount of noise added as a function of time, allowing the noise to be applied in a manner that is systematic and controllable across different input images received by the pre-trained diffusion model 210. The controlled noise added can be done iteratively by processing the input image through the diffusion stage described with reference to pre-training the diffusion model 210, above.

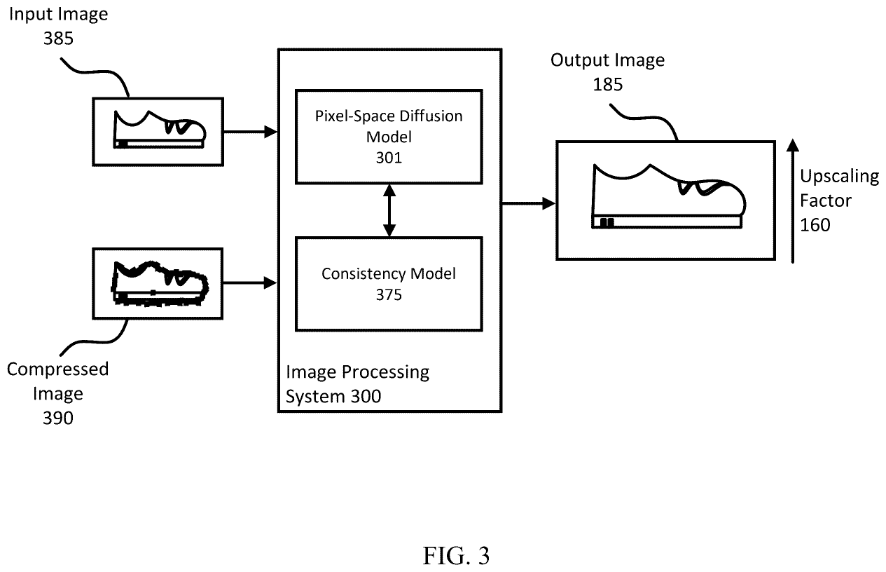

In examples in which the pre-trained diffusion model 210 is a pixel-space diffusion model, aspects of the disclosure provide for training a consistency model to reduce the number of steps in denoising stage can be reduced to a single inference step, and to reduce training, such as to a single round of training on an available set of training data. FIG. 3 and its corresponding description provide examples herein for processing pixel-space diffusion models using a consistency model. To that end, instead of processing the input image through the diffusion model multiple times to generate the output image, a consistency model can be trained and applied for reducing the number of iterations, e.g., thirty-two, to a single step.

The training data 270 can be provided to the training engine 200 for training the model 101. The training engine 200 can begin with the pre-trained diffusion model 210, fine-tuning the model 210 using the training data 270. For example, the training engine 200 can perform one or more fine-tuning iterations, each iteration including a forward pass of the training data 270 through the model 101, followed by computing a loss, and then performing backpropagation with gradient descent to update model parameter values for the model 101. The training iteration can follow, for example, a supervised learning approach, or another approach that can be used to train diffusion models for super-resolution. The loss function used to fine-tune the model 101 can be MSE, weighted MSE loss, L1 loss, huber loss, or any of a variety of different loss functions used to train diffusion models for super-resolution upscaling.

FIG. 3 is a block diagram of an image processing system 300 implementing a pixel-space diffusion model 301 with a consistency model 375, according to aspects of the disclosure. A potential bottleneck in diffusion models is in the denoising stage, in which a number of iterations are performed as part of denoising input to iteratively refine an image until the output image is generated. Directly reducing the number of denoising operations performed in steps in the denoising stage will reduce processing speed but result in quality reduction.

As compared with implementing consistency models for latent-space diffusion model, the pixel-space diffusion model 301 acting as the teacher model allows the consistency model to be directly generate human readable images instead of latent representations, hence without dependency on decoders to recover images from a compressed space.

Image processing system 300 can receive a variety of types of image inputs, e.g., input image 385 or compressed image 390. The image processing system 300 can implement a pixel-space diffusion model 301 for performing super-resolution upscaling on the input image 385. In some examples, the pixel-space diffusion model 301 can be trained to perform the super-resolution upscaling with compression artifact restoration, for example like the model 101 as shown and described with reference to FIG. 1. In these examples, the model 301 can receive compressed images, e.g., compressed image 390, for generating the output image 185, which can be a higher-resolution version of the input image upscaled in accordance with the upscaling factor 160.

A consistency model can be employed to reduce the iteration to only a single step, by learning a probabilistic flow ordinary differential equation (ODE). A transformation of data to pure noise can be modeled using one or more ODEs. An ODE is considered self-consistent when the ODE maps points along the same trajectory back to their common initial point. For example, an initial input x₀ at time step zero can be represented by the pair (x₀, 0). During the diffusion stage, an input xₜ can represent the image at timestep t, which can be represented by the pair (xₜ, t). The sequence of images at subsequent timestamps, e.g., (x₀, 0), (x₁, 1) . . . (xₜ, t), can be referred to as the trajectory of images over a sequence of timesteps.

The consistency model 375 can be trained by distillation of the pixel-space diffusion model 301. Distillation in this context means to mirror or emulate the outputs of the diffusion model 301, using the consistency model 375. The consistency model 375 directly predicts the original image x₀ given any intermediate step and its corresponding timestamp within the solution trajectory. The consistency model 375 is an ODE f_{θ} with parameters θ such that f_{θ}(xₜ, t)=x₀.

The consistency model 375 can share the same architecture as the model 301, e.g., be implemented as a pixel-space diffusion model 301. The consistency model 375 implements an ODE to map data to noise during the diffusion stage across multiple diffusion steps with each step including one or more diffusion operations performed by the a system executing the consistency model 375, while maintaining this self-consistency property for all inputs x and all timesteps t up to the last diffusion step outputting pure noise, represented as (x_{T}, T). Once trained, the consistency model 375 can enable single-step generation of an image, even from pure noise. The diffusion model adds noise to the input x₀ such that when the noised input is provided to the consistency model 375, the consistency model 375 generates a super-resolution output image of the input. As described herein, the diffusion model 375 can be trained to add and remove noise for generating a target super-resolution output image from an input image that has been upscaled, for example using bilinear upscaling.

To train the consistency model 375, a model training engine, e.g., the training engine 200 of FIG. 2, can provide an image x and generate an adjacent pair of outputs on the ODE trajectory at timestamps tₙ₊₁ and tₙ. The training engine 200 adds noise at one point using x at timestep tₙ₊₁, represented as Xₜ_{ₙ₊₁}, and adds noise to the other output using the pixel-space diffusion model 301, represented as zₜ_{ₙ}. In other words, the point zₜ_{ₙ} is the original input x to the pixel-space diffusion model 301 noised at the diffusion step corresponding to timestep tₙ.

The outputs of processing the consistency model 375 on zₜ_{ₙ} and xₜ_{ₙ₊₁} can be compared, with their differences minimized as the objective for backpropagating and updating model parameters of both the consistency model 375 and the pixel-space diffusion model 301. To that end, the objective pushes the consistency model 375 and the pixel-space diffusion model 301 to generate outputs that are on the same trajectory to point back to the initial input image x₀. An example formulation of the loss function is:

$$L ( θ ; Φ ) = E [ λ ( {t}_{n} ) d ( {f}_{θ} ( {x}_{{t}_{n + 1}} , {t}_{n + 1} ) , {f}_{θ} ( {z}_{{t}_{n}} , {t}_{n} ) ]$$

Loss function L(·) is used to update model parameters for consistency model 375 (θ) and model parameters for pixel-space diffusion model 301 (Φ). E(·) is the expected value function, λ(·) is a weighting function, for example generating a constant value or generating a value depending on the timestep, n˜[1, T] is a timestep sampled from the first timestep to the last timestep T, and d(·) is the distance metric used to measure the distance between the output images of the consistency model 375 and the pixel-space diffusion model 201.

The weights of the consistency model 375 can be initialized using the weights of the pixel-space diffusion model 301. A copy of the exponential moving average (EMA) for the consistency model parameters, which is initialized from the pixel-space diffusion model 210 is stored and maintained during training. The EMA for the model parameters of the consistency model 210 is an exponentially decaying average that the training engine training the models can use to generate a set of EMA weights. Rather than updating the weights of the pixel-space diffusion model 201, which are typically frozen during distillation, in some examples, EMA weights are updated, instead. Instead of updating the EMA weights during backpropagation of the weights for the consistency model 375, the EMA weights for the pixel-space diffusion model can be updated at the end of each iteration, using the weights of the consistency model 375.

The EMA weights can be used as the weights for the final consistency model, leading to improved training stability and better results, versus the more computationally intensive process of updating the EMA weights during backpropagation of the weights for the consistency model 375. When the EMA weights are used, the loss function can be represented as:

$$L ( θ ; Φ ) = E [ λ ( {t}_{n} ) d ( {f}_{θ} ( {x}_{{t}_{n + 1}} , {t}_{n + 1} ) , {f}_{{θ}^{ema}} ( {z}_{{t}_{n}} , {t}_{n} ) ]$$

f_{θ}^{ema}(·) is the output of the consistency model 301 using the EMA weights. At the end of training, e.g., after one or more stopping criteria are met, the EMA weights can be used as the weights for the consistency model 301. After training the consistency model 375, the model can be used to directly generate an image from pure noise in one single step using any sampler, e.g., using DDIM or any type of sampler that can be used with a diffusion model.

The system 300 can generate upscaled images according to an upscaling factor, for example as shown and described in FIG. 1 with reference to the system 100 and the upscaling factor 160. In some examples, the upscaling factor offered by the system 300 can vary to trade-off with architectural complexity of the pixel-space diffusion model 301 and subsequently, the time to process input through the model 301. For example, when the upscaling factor for the system 300 is 2×, the number of size or quantity of sub-components for the model 301 can be reduced, for example by reducing the number of sub-blocks in a U-net implemented as part of the model 301. In some examples, system 100 for super-resolution with compression artifact restoration can be implemented with a consistency model to improve inference processing during the denoising stage. In some examples, the system 300 is trained only for super-resolution upscaling, e.g., on non-compressed image input.

FIG. 4 is a block diagram illustrating one or more models 410, such as for deployment in a datacenter 420 housing one or more hardware accelerators 430 on which the deployed models will execute for super-resolution upscaling with compression artifact restoration. The hardware accelerators 430 can be any type of processor, such as a central processing unit (CPU), graphics processing unit (GPU), field-programmable gate array (FPGA), or an application-specific integrated circuit (ASIC), such as a tensor processing unit (TPU).

An input image for processing can be processed through a hardware accelerator, for example one or more of hardware accelerators 430. A predetermined threshold dimension can be set for the height and width of the input image, e.g., 512 pixels tall and 512 pixels wide. The system 100 can check whether the input image is within the predetermined threshold dimension. If so, an image processing system, e.g., the system 100 or the system 300, can pre-process the image in part by padding the image until the image dimension matches the threshold dimension. If the system determines that the input image exceeds the threshold dimension in at least one dimension, the system can reject the input image and/or send a notification indicating that the input image was rejected for having an improper resolution. In some examples, the system can crop the input image to within the threshold dimension, for example by removing padding around the input image.

The upscaling factor can be selected based on the predetermined threshold dimension, or vice versa. In one example, the threshold dimension is 512×512 pixels, with a 4× upscaling factor. As another example, the threshold dimension is doubled, e.g., 1024×1024 pixels, and the upscaling factor is halved, e.g., a 2× upscaling factor. Other combinations of upscaling factor and threshold dimension are possible, and based on, for example, hardware limitations of hardware accelerators or other devices processing the model during training and/or inference. After processing, the system can crop the image back to its original aspect ratio with respect to the upscaling factor.

Various different data formats may be used for input data and intermediate data to the model, including bfloat16 and float32. The consistency model can share the same architecture as the AI model, with a similar memory footprint. When implemented with the bloat16 data type, less memory is used overall, and multiple instances of processing at inference can be performed concurrently. The same or different formats can be used during training and serving the model.

The models 410 can be of any architecture, e.g., of a diffusion model, or a consistency model, as described herein with reference to FIGS. 1-4. An architecture of a model can refer to characteristics defining the model, such as characteristics of layers for the model, how the layers process input, or how the layers interact with one another. For example, the model can be a convolutional neural network that includes a convolution layer that receives input data, followed by a pooling layer, followed by a fully connected layer that generates a result. The architecture of the model can also define types of operations performed within each layer.

For example, the architecture of a convolutional neural network may define that rectified linear unit (ReLU) activation functions are used in the fully connected layer of the network. Other example architectures can include generative models, such as language models, foundation models, and/or graphical models. One or more model architectures can be generated that can output results associated with super-resolution upscaling with compression artifact restoration.

In some examples, the techniques disclosed herein enable artificial intelligence to perform super-resolution upscaling with compression artifact restoration. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, a supervised learning technique can be applied to calculate an error between outputs, with a ground-truth label of a training example processed by the model.

Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

The model(s) can be pre-trained before domain-specific alignment. For instance, a model can be pre-trained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

The model can be modified or updated until stopping criteria are met, such as a number of iterations for training, a maximum period of time, a convergence of estimated rewards or value between actions, or when a minimum value threshold is met. A model can be a composite of multiple models or components of a processing or training pipeline. In some examples, the models or components are trained separately, while in other examples, the models or components are trained end-to-end.

### Example Methods

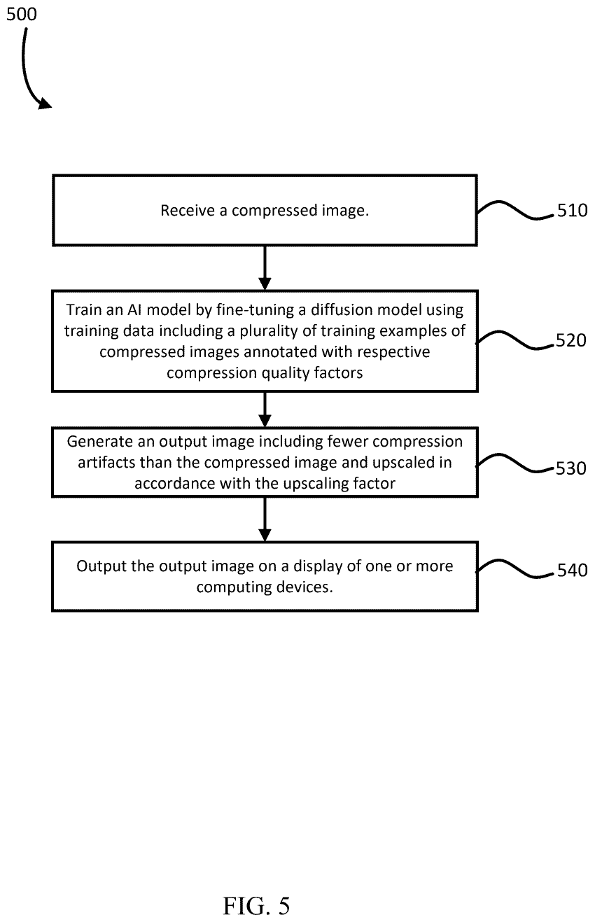

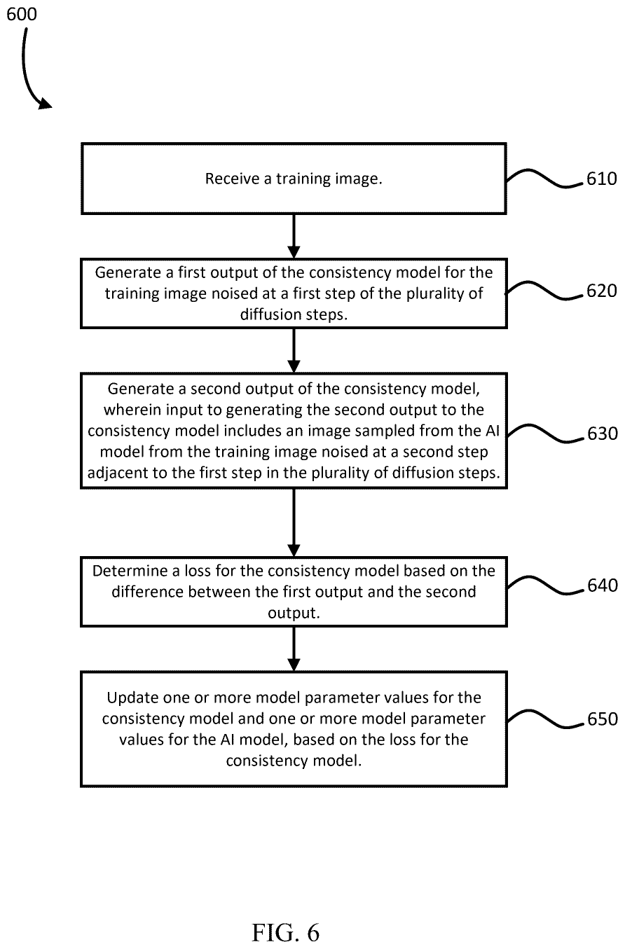

FIG. 5 is a flow diagram of an example process 500 for generating super-resolution upscaled images with compression artifact restoration, according to aspects of the disclosure. The following operations, for example with reference to the process 500 and process 600 of FIGS. 5 and 6, do not have to be performed in the precise order described below. Rather, various operations can be performed in a different order or simultaneously, and operations may be added or omitted. In some examples, part or all of processes 500 and 600 are performed together, either in parallel or at different times, by an image processing system. The example process 500 can be performed on a system of one or more processors in one or more locations, such as the image processing system 100 of FIG. 1 of the image processing system 300 of FIG. 3.

The system receives a compressed image, according to block 510. The compressed image can be lossily compressed with one or more compression artifacts, for example as described herein with reference to FIG. 1. In some examples, the compressed image is a JPEG image.

The system trains an AI model by fine-tuning a diffusion model using training data including a plurality of training examples of compressed images annotated with respective compression quality factors, according to block 520. For example, as described with reference to FIG. 2, the system can implement a training engine to fine-tune a diffusion model with training examples of randomly compressed images annotated with corresponding compression quality factors. In some examples, the training examples can be annotated with the respective quality factors using a quality factor prediction engine trained to predict compression quality factors of input compressed images. The trained AI model can be a super-resolution and compression artifact restoration model, for example as described with reference to FIG. 2,

In generating the trained AI model, the system can fine-tune the diffusion model, by first receiving and providing the training examples to the diffusion model. The system can determine a loss using output of the diffusion model from the plurality of training examples, and update, in accordance with the loss, one or more model parameter values of the diffusion model. For example, the system can perform backpropagation with gradient descent, to update the model parameter values using the calculated loss.

The system generates an output image including fewer compression artifacts than the compressed image and upscaled in accordance with the upscaling factor, according to block 530. For example, and referring to FIG. 2, the system can process an input through the super-resolution and compression artifact restoration model 101, fine-tuned on the pre-trained diffusion model 210 using the generated training data 270.

The system outputs the output image on a display of one or more computing devices, according to block 540. For example, the output image may be generated in response to a request for content meeting a certain resolution or scaling factor the system is configured to generate using a super-resolution and compression artifact restoration model. In some examples, the system causes the output image to be output to the display of a computing device, for example by generating the output image and sending the image to the computing device. In turn the computing device can be configured to display the output image, for example automatically, or in response to a received request for the image.

FIG. 6 is a flow diagram of an example process for training a consistency model using a pixel-space diffusion model, according to aspects of the disclosure. The example process 600 can be performed on a system of one or more processors in one or more locations, such as the image processing system 300 of FIG. 3.

The system receives a training image, according to block 610. The image can be a compressed image, for example as described with reference to FIG. 3.

The system generates a first output of the consistency model for the training image noised at a first step of the plurality of diffusion steps, according to block 620.

The system generates a second output of the consistency model, wherein input to generating the second output to the consistency model includes an image sampled from the AI model from the training image noised at a second step adjacent to the first step in the plurality of diffusion steps, according to block 630.

For example, to perform the receiving and generating steps according to block 610 through 630, the system can implement a training engine that is provided with an image x and generates an adjacent pair of outputs on the ODE trajectory at timestamps tₙ₊₁ and tₙ. The training engine adds noise at one point using x at timestep tₙ₊₁, represented as xₜ_{ₙ₊₁} and corresponding to the first output, and adds noise to the other output using the pixel-space diffusion model 301, represented as zₜ_{ₙ} and corresponding to the second output.

The system determines a loss for the consistency model based on the difference between the first output and second output, according to block 640. For example, the outputs of processing the consistency model 375 on zₜ_{ₙ} and Xₜ_{ₙ₊₁} can be compared, with their differences minimized as the objective for backpropagating and updating model parameters of both the consistency model 375 and the pixel-space diffusion model. To that end, the objective pushes the consistency model 375 and the pixel-space diffusion model 101 to generate outputs that are on the same trajectory to point back to the initial input image x₀.

The system updates one or more model parameter values for the consistency model and one or more model parameter values for the AI model, based on the loss for the consistency model, according to block 650. For example, the loss can be the loss described with reference to FIG. 3. The process 600 can be repeated for a number of iterations, until meeting one or more stopping criteria, for example as discussed with reference to FIGS. 2 and 3.

Implementations of the present technology can each include, but are not limited to, the following. The features may be alone or in combination with one or more other features described herein. In some examples, the following features are included in combination:
(1) A method, including: receiving, by one or more processors, a compressed image including compression artifacts; training, by the one or more processors, an artificial intelligence (AI) model by fine-tuning a diffusion model using training data including a plurality of training examples of compressed images annotated with respective compression quality factors, the diffusion model trained to perform super-resolution upscaling in accordance with an upscaling factor; generating, by the one or more processors, an output image including fewer compression artifacts than the compressed image and upscaled in accordance with the upscaling factor, the generating including providing the compressed image as input to the AI model; and outputting, by the one or more processors, the output image on a display of one or more computing devices.
(2) The method of (1), wherein training the AI model by fine-tuning the diffusion model includes: determining, by the one or more processors, a loss using an output of the diffusion model from the plurality of training examples; and updating, by the one or more processors and in accordance with the loss, one or more model parameter values of the diffusion model.
(3) The method of (2), wherein generating the output image includes: adding noise, by the one or more processors, to the compressed image along a plurality of diffusion steps corresponding to diffusion operations to add noise to the compressed image; and removing noise, by the one or more processors, from the noised compressed image along one or more denoising steps corresponding to denoising operations to remove noise and generate the output image.
(4) The method of (3), wherein the AI model is a pixel-space diffusion model.
(5) The method of (4), wherein removing noise from the noised compressed image along the one or more denoising steps includes processing, by the one or more processors, the noised compressed image through a consistency model trained to generate the output image by evaluating a probabilistic flow ordinary differential equation (ODE).
(6) The method of (5), further including training the consistency model, the training including performing, by the one or more processors, one or more iterations of: receiving a training image; generating a first output of the consistency model for the training image noised at a first step of the plurality of diffusion steps; generating a second output of the consistency model, wherein input to generating the second output to the consistency model includes an image sampled from the AI model from the training image noised at a second step adjacent to the first step in the plurality of diffusion steps; determining, by the one or more processors, a loss for the consistency model based on the difference between the first output and the second output; and updating, by the one or more processors, one or more model parameter values for the consistency model and one or more model parameter values for the AI model, based on the loss for the consistency model.
(7) The method of any one of (1) through (6), wherein receiving the training data includes: receiving, by the one or more processors, an image compressed in accordance with a compression quality factor; and generating, by the one or more processors, the compression quality factor as a label for the image.
(8) The method of (7), wherein generating the compression quality factor includes: training, by the one or more processors, a second AI model over one or more training iterations to predict an output compression quality factor in accordance with the compression of a received input image; and generating, by the one or more processors, the compression quality factor as the label for the image using the second AI model.
(9) The method of either (7) or (8), wherein receiving the training data further includes: generating, by the one or more processors, the plurality of training examples with respective randomly selected compression quality factors.
(10) The method of any one of (1) through (9), wherein each compressed image in the training data is lossily compressed.
(11) A system including one or more processors and memory, the system configured to perform, by the one or more processors, operations of the method of any one of (1) through (10).
(12) One or more non-transitory computer-readable storage media storing instructions that are operable, when executed by one or more processors, to cause the one or more processors to perform operations as in any one of (1) through (10).

### Example Computing Environment

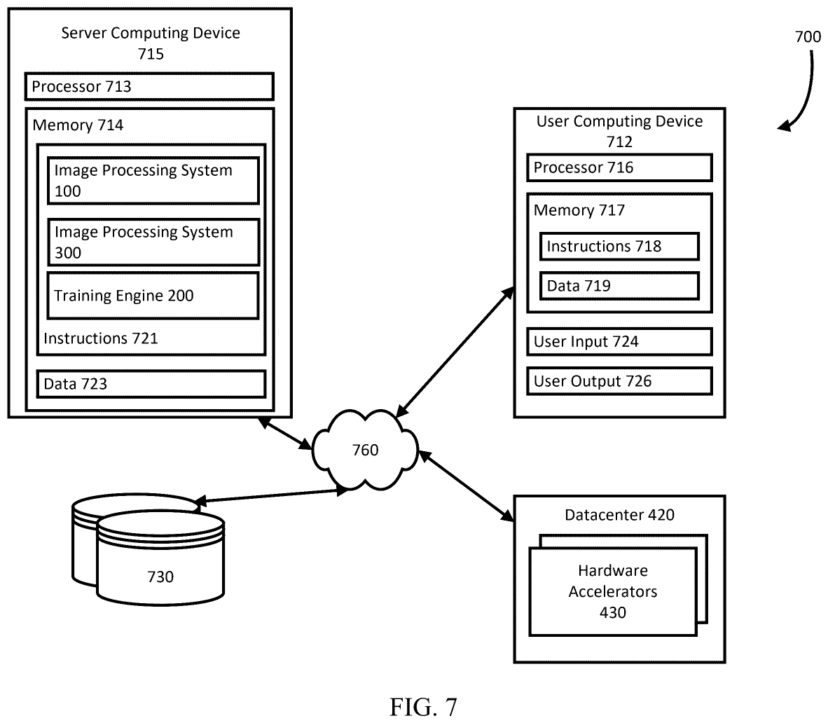

FIG. 7 is a block diagram of an example computing environment 700 for implementing an image processing system, according to aspects of the disclosure. The image processing system can be, for example, the image processing system 100 or the image processing system 300. The system 100, the system 300, and/or other engines or modules described herein can be implemented on one or more devices having one or more processors in one or more locations, such as in server computing device 715. User computing device 712 and the server computing device 715 can be communicatively coupled to one or more storage devices 730 over a network 760. The storage device(s) 730 can be a combination of volatile and non-volatile memory and can be at the same or different physical locations than the computing devices 712, 715. For example, the storage device(s) 730 can include any type of non-transitory computer readable medium capable of storing information, such as a hard-drive, solid state drive, tape drive, optical storage, memory card, ROM, RAM, DVD, CD-ROM, write-capable, and read-only memories.

Aspects of the disclosure can be implemented in a computing system that includes a back-end component, e.g., as a data server, a middleware component, e.g., an application server, or a front-end component, e.g., user computing device 712 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet. The datacenter #20 can also be in communication with the user computing device 712 and the server computing device 715.

The computing system can include clients, e.g., user computing device 712 and servers, e.g., server computing device 715. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 715 can include one or more processors 713 and memory 714. The memory 714 can store information accessible by the processor(s) 713, including instructions 721 that can be executed by the processor(s) 713. The memory 714 can also include data 723 that can be retrieved, manipulated, or stored by the processor(s) 713. The memory 714 can be a type of non-transitory computer readable medium capable of storing information accessible by the processor(s) 713, such as volatile and non-volatile memory. The processor(s) 713 can include one or more central processing units (CPUs), graphic processing units (GPUs), field-programmable gate arrays (FPGAs), and/or application-specific integrated circuits (ASICs), such as tensor processing units (TPUs).

The instructions 721 can include one or more instructions that when executed by the processor(s) 713, causes the one or more processors to perform actions defined by the instructions. The instructions 721 can be stored in object code format for direct processing by the processor(s) 713, or in other formats including interpretable scripts or collections of independent source code modules that are interpreted on demand or compiled in advance. The instructions 721 can include instructions for implementing an image processing system consistent with aspects of this disclosure. The system 100 can be executed using the processor(s) 713, and/or using other processors remotely located from the server computing device 715.

The data 723 can be retrieved, stored, or modified by the processor(s) 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII, or Unicode. Moreover, the data 723 can include information sufficient to identify relevant information, such as numbers, descriptive text, proprietary codes, pointers, references to data stored in other memories, including other network locations, or information that is used by a function to calculate relevant data. The term “database” refers to any collection of data. The data can be unstructured or structured in any manner. The data can be stored on one or more storage devices in one or more locations. For example, an index database can include multiple collections of data, each of which may be organized and accessed differently.

The user computing device 712 can also be configured similarly to the server computing device 715, with one or more processors 716, memory 717, instructions 718, and data 719. For example, the user computing device 712 can be a mobile device, a laptop, a desktop computer, a game console, etc. The user computing device 712 can also include a user output 726, and a user input 724. The user input 724 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 724 can include a keyboard, mouse or other point device, mechanical actuators, soft actuators, touchscreens, microphones, and sensors.

The server computing device 715 can be configured to transmit data to the user computing device 712, and the user computing device 712 can be configured to display at least a portion of the received data on a display implemented as part of the user output 726. The user output 726 can also be used for displaying an interface between the user computing device 712 and the server computing device 715. The user output 726 can alternatively or additionally include one or more speakers, transducers or other audio outputs, a haptic interface or other tactile feedback that provides non-visual and non-audible information to the platform user of the user computing device 712.

Although FIG. 7 illustrates the processors 713, 716 and the memories 714, 717 as being within the computing devices 715, 712, components described in this specification, including the processors 713, 716 and the memories 714, 717 can include multiple processors and memories that can operate in different physical locations and not within the same computing device. For example, some of the instructions 721, 718 and the data 723, 719 can be stored on a removable SD card and others within a read-only computer chip. Some or all of the instructions and data can be stored in a location physically remote from, yet still accessible by, the processors 713, 716. Similarly, the processors 713, 716 can include a collection of processors that can perform concurrent and/or sequential operation. The computing devices 715, 712 can each include one or more internal clocks providing timing information, which can be used for time measurement for operations and programs run by the computing devices 715, 712.

The server computing device 715 can be configured to receive requests to process data from the user computing device 712. For example, the environment 700 can be part of a computing platform configured to provide a variety of services to users, through various user interfaces and/or APIs exposing the platform services. One or more services can be a machine learning framework or a set of tools for training or executing generative models or other machine learning models according to a specified task and training data.

The devices 712, 715 can be capable of direct and indirect communication over the network 760. The devices 715, 712 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. The network 760 can support a variety of short- and long-range connections. The short- and long-range connections may be made over different bandwidths, such as 2.402 GHz to 2.480 GHz (commonly associated with the Bluetooth® standard), 2.4 GHz and 5 GHZ (commonly associated with the Wi-Fi® communication protocol); or with a variety of communication standards, such as the LTE® standard for wireless broadband communication. The network 760, in addition or alternatively, can also support wired connections between the devices 712, 715, including over various types of Ethernet connection.

Although a single server computing device 715, user computing device 712, and datacenter #20 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus. A computer program may, but need not, correspond to a file in a file system. A computer program can be stored in a portion of a file that holds other programs or data, e.g., one or more scripts, in a single file, or in multiple coordinated files, e.g., files that store one or more engines, modules, sub-programs, or portions of code.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable storage media, including transitory or non-transitory computer-readable storage media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 712, the server computing device 715, or the hardware accelerators 430.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method, comprising:
receiving, by one or more processors, a compressed image comprising compression artifacts;
training, by the one or more processors, an artificial intelligence (AI) model by fine-tuning a diffusion model using training data comprising a plurality of training examples of compressed images annotated with respective compression quality factors, the diffusion model trained to perform super-resolution upscaling in accordance with an upscaling factor;
generating, by the one or more processors, an output image comprising fewer compression artifacts than the compressed image and upscaled in accordance with the upscaling factor, the generating comprising providing the compressed image as input to the AI model; and
outputting, by the one or more processors, the output image on a display of one or more computing devices.

2. The method of claim 1, wherein training the AI model by fine-tuning the diffusion model comprises:
determining, by the one or more processors, a loss using an output of the diffusion model from the plurality of training examples; and
updating, by the one or more processors and in accordance with the loss, one or more model parameter values of the diffusion model.

3. The method of claim 2, wherein generating the output image comprises:
adding noise, by the one or more processors, to the compressed image along a plurality of diffusion steps corresponding to diffusion operations to add noise to the compressed image; and
removing noise, by the one or more processors, from the noised compressed image along one or more denoising steps corresponding to denoising operations to remove noise and generate the output image.

4. The method of claim 3, wherein the AI model is a pixel-space diffusion model.

5. The method of claim 4, wherein removing noise from the noised compressed image along the one or more denoising steps comprises processing, by the one or more processors, the noised compressed image through a consistency model trained to generate the output image by evaluating a probabilistic flow ordinary differential equation (ODE).

6. The method of claim 5, further comprising training the consistency model, the training comprising performing, by the one or more processors, one or more iterations of:
receiving a training image;
generating a first output of the consistency model for the training image noised at a first step of the plurality of diffusion steps;
generating a second output of the consistency model, wherein input to generating the second output to the consistency model comprises an image sampled from the AI model from the training image noised at a second step adjacent to the first step in the plurality of diffusion steps;
determining, by the one or more processors, a loss for the consistency model based on the difference between the first output and the second output; and
updating, by the one or more processors, one or more model parameter values for the consistency model and one or more model parameter values for the AI model, based on the loss for the consistency model.

7. The method of claim 1, wherein receiving the training data comprises:
receiving, by the one or more processors, an image compressed in accordance with a compression quality factor; and
generating, by the one or more processors, the compression quality factor as a label for the image.

8. The method of claim 7, wherein generating the compression quality factor comprises:
training, by the one or more processors, a second AI model over one or more training iterations to predict an output compression quality factor in accordance with the compression of a received input image; and
generating, by the one or more processors, the compression quality factor as the label for the image using the second AI model.

9. The method of claim 7, wherein receiving the training data further comprises:
generating, by the one or more processors, the plurality of training examples with respective randomly selected compression quality factors.

10. The method of claim 1, wherein each compressed image in the training data is lossily compressed.

11. A system, comprising:
one or more processors configured to:
receive a compressed image comprising compression artifacts;
train an artificial intelligence (AI) model by fine-tuning a diffusion model using training data comprising a plurality of training examples of compressed images annotated with respective compression quality factors, the diffusion model trained to perform super-resolution upscaling in accordance with an upscaling factor;
generate an output image comprising fewer compression artifacts than the compressed image and upscaled in accordance with the upscaling factor, the generating comprising providing the compressed image as input to the AI model; and
output the output image on a display of one or more computing devices.

12. The system of claim 11, wherein in training the AI model, the one or more processors are configured to:
determine a loss using an output of the diffusion model from the plurality of training examples; and
update, in accordance with the loss, one or more model parameter values of the diffusion model.

13. The system of claim 12, wherein in generating the output image, the one or more processors are configured to:
add noise to the compressed image along a plurality of diffusion steps corresponding to diffusion operations to add noise to the compressed image; and
remove noise from the noised compressed image along one or more denoising steps corresponding to denoising operations to remove noise and generate the output image.

14. The system of claim 13, wherein the AI model is a pixel-space diffusion model.

15. The system of claim 14, wherein in removing noise from the noised compressed image along the one or more denoising steps, the one or more processors are configured to process the noised compressed image through a consistency model trained to generate the output image by evaluating a probabilistic flow ordinary differential equation (ODE).

16. The system of claim 15, wherein the one or more processors are further configured to train the consistency model, wherein in training the consistency model the one or more processors are configured to perform one or more iterations of:
receiving a training image;
generating a first output of the consistency model for the training image noised at a first step of the plurality of diffusion steps;
generating a second output of the consistency model, wherein input to generating the second output to the consistency model comprises an image sampled from the AI model from the training image noised at a second step adjacent to the first step in the plurality of diffusion steps;
determining, by the one or more processors, a loss for the consistency model based on the difference between the first output and the second output; and
updating, by the one or more processors, one or more model parameter values for the consistency model and one or more model parameter values for the AI model, based on the loss for the consistency model.

17. The system of claim 11, wherein in receiving the training data, the one or more processors are configured to:
receive an image compressed in accordance with a compression quality factor; and
generate the compression quality factor as a label for the image.

18. The system of claim 17, wherein in generating the compression quality factor, the one or more processors are configured to:
train a second AI model over one or more training iterations to predict an output compression quality factor in accordance with the compression of a received input image; and
generate the compression quality factor as the label for the image using the second AI model.

19. The system of claim 17, wherein in receiving the training data, the one or more processors are configured to:
generate the plurality of training examples with respective randomly selected compression quality factors.

20. One or more non-transitory computer-readable storage media, storing instructions that when executed by one or more processors, cause the one or more processors to perform operations for:
receiving a compressed image comprising compression artifacts;
training an artificial intelligence (AI) model by fine-tuning a diffusion model using training data comprising a plurality of training examples of compressed images annotated with respective compression quality factors, the diffusion model trained to perform super-resolution upscaling in accordance with an upscaling factor;
generating an output image comprising fewer compression artifacts than the compressed image and upscaled in accordance with the upscaling factor, the generating comprising providing the compressed image as input to the AI model; and
outputting the output image to be output on a display of one or more computing devices.
